(19) United States
(12) Patent Application Publication
(10) Pub. No.: US 2023/0126050 A1
(43) Pub. Date: Apr. 27, 2023

(54) DURABLE AND SERVICEABLE PLASMA REACTOR FOR FERTILIZER PRODUCTION

(71) Applicant: Nitricity Inc., San Franacisco, CA (US)

(72) Inventors: John A. SCHWALBE, Redwood City, CA (US); Joshua M. Mcenaney, San Francisco, CA (US); Nicolas H. Pinkowski, San Francisco, CA (US)

(21) Appl. No.: 17/970,075

(22) Filed: Oct. 20, 2022

Related U.S. Application Data
(60) Provisional application No. 63/270,401, filed on Oct. 21, 2021.

(51) Int. Cl. B01J 19/08; H05H 1/48; B01J 19/26; B01J 19/00; C01B 21/38; C05C 5/00

(52) U.S. Cl. CPC B01J 19/088; B01J 19/0006; B01J 19/26; C01B 21/38; C05C 5/00; H05H 1/482; B01J 2219/083; B01J 2219/0801; B01J 2219/0809; B01J 2219/0869; B01J 2219/0871; B01J 2219/0875; B01J 2219/0896; H05H 2242/10; H05H 2245/10

(57) ABSTRACT

Aspects of the present disclosure involve a gliding-arc type plasma reactor for use in nitrogen-based fertilizer production. The plasma reactor may include a pair of electrodes oriented in a plane within an enclosure. A pair of sheaths may attach to a corresponding electrode, with each included a strike point surface oriented to face the other sheath. The electrodes may further include an inner channel through which a cooling fluid may be pumped for heat control. A gas injection system may also be included to inject a gas into the chamber for interacting with the plasma arc and may or may not include an adjustable nozzle. The nozzle may direct air flow, including the gas, at a location at which the plasma arc may occur. The device provides for a long lifetime of components within the device and easy replacement and maintenance of the components of high-wear items.

### CROSS-REFERENCE TO RELATED APPLICATION

This application is related to and claims priority under 35 U.S.C. § 119(e) from U.S. Pat. Application No. 63/270,401 filed Oct. 21, 2021, entitled “DURABLE AND SERVICEABLE PLASMA REACTOR FOR FERTILIZER PRODUCTION,” the entire contents of which is incorporated herein by reference for all purposes.

### TECHNICAL FIELD

Embodiments of the present invention generally relate to systems and methods for plasma-based fertilizer production, and more specifically for a plasma reactor and method to produce a non-thermal plasma for chemical production, such as nitrogen fixation.

### BACKGROUND AND INTRODUCTION

Nitrogen-based fertilizer production, used throughout the world for agricultural purposes, may include one or more industrial processes to generate components of the fertilizer. The oxidation of nitrogen using a plasma is an important route to fixed nitrogen for use in nitrogen-based fertilizers. This oxidation process occurs naturally in lightning storms and has been historically used on an industrial scale to create fertilizer in a process known as the Birkeland-Eyde process. A hydrocarbon-based process, known as the Haber-Bosch process, soon followed for ammonia synthesis. After over a century, advances in materials science, plasma physics, and power electronics have led to a renewed interest in plasma-based fertilizer production. In the Birkeland-Eyde process, electrical arcs were created that reacted with nitrogen and/or oxygen to create gas-phase oxidized-nitrogen species, which were then reacted with water to produce nitric acid. Nitric acid may be used as a source of nitrate for nitrogen-based fertilizers.

A particular type of plasma reactor, known as a gliding-arc reactor, has also been previously used for nitrogen fixation. While traditional Birkeland-Eyde reactors used a plasma arc between two points spread by a magnetic field, its competitor, the Pauling process, used a gliding-arc design, in which the arc is spread by diverging electrodes with a stream of gas moving through the arc. One major challenge to both Birkeland-Eyde reactors and gliding-arc reactors is the longevity of the plasma reactor, as the region experiences large voltages, electric arcs, andthe presence of oxidizing and corrosive chemicals like nitric acid, ozone, and nitrous oxides. These byproducts may quickly degrade the materials and components of the reactor, requiring frequent maintenance and replacement of components, often in environments in which maintenance of the reactor is complicated and expensive.

It is with these observations in mind, among others, that aspects of the present disclosure were conceived and developed.

### SUMMARY

One aspect of the present disclosure relates to a plasma reactor comprising a first electrode and a second electrode, each comprising a strike portion proximate to a corresponding strike portion of the other of the first electrode and the second electrode, a gas injector injecting a gas stream between the first electrode and the second electrode, wherein a plasma arc is generated between the first electrode and the second electrode to oxidize nitrogen in the gas stream, and an enclosure through which the first electrode and the second electrode and the gas injector enter a sealed chamber, the enclosure comprising a removable portion to provide service access to the sealed chamber.

Another aspect of the present disclosure relates to a method for controlling a plasma reactor. The method may include the operations of providing a first electrode and a second electrode each comprising a strike portion proximate to a corresponding strike portion of the other of the first electrode and the second electrode, providing an enclosure through which the first electrode and the second electrode and a gas injector enter a sealed chamber, at least a portion of the enclosure removable to provide service access to the sealed chamber, and injecting, via a gas injector, a gas stream between the first electrode and the second electrode, wherein a plasma arc is generated between the first electrode and the second electrode to oxidize the gas stream.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1A is a front view of a plasma reactor, with a front wall of the plasma reactor not shown to illustrate the components with an interior chamber of the plasma reactor.

FIG. 1B is an isometric view of the interior chamber of the plasma reactor of FIG. 1A.

FIG. 2A is a top perspective view of a first type of bushing of the plasma reactor of FIG. 1A.

FIG. 2B is a bottom perspective view of a first type of bushing of the plasma reactor of FIG. 1A.

FIG. 2C is a cross-section diagram of a second type of bushing of the plasma reactor of FIG. 1A.

FIG. 3A is a first cross-section diagram of the electrode of the plasma reactor of FIG. 1A.

FIG. 3B is a second cross-section diagram of the electrode of the plasma reactor of FIG. 1A.

FIG. 4A is a perspective view of a striking sheath of the plasma reactor of FIG. 1A.

FIG. 4B is a front view of the striking sheath of the plasma reactor of FIG. 1A.

FIG. 5 is a representative diagram of the interior chamber of the plasma reactor of FIG. 1A illustrating a gas-injection nozzle.

FIG. 6 is a diagram of an exterior of a plasma reactor.

FIG. 7 is a flowchart of a method for operating a plasma reactor.

FIG. 8 is a diagram illustrating an example of a computing system which may be used in implementing embodiments of the present disclosure.

### DETAILED DESCRIPTION

Aspects of the present disclosure involve a gliding-arc type plasma reactor for use in nitrogen-based fertilizer production. Gliding-arc plasma reactors have a natural tendency to produce electric arcs with a favorable combination of electric field and plasma temperature. By encouraging these conditions, an appropriately designed reactor can efficiently produce nitrogen compounds for fertilizer. However, gliding-arc plasma reactors generally include harsh environments and conditions that wear reactor components quickly due to the large voltages, electric arcs, and the presence of oxidizing and corrosive chemicals. Further, replacement of worn components and other general maintenance of the plasma reactor may be difficult as reactors enclosures are often robustly constructed for safety purposes. Provided herein is a plasma reactor with structures, properties, and materials that overcome these challenges to provide a durable and serviceable plasma reactor for widely distributed in-field use and otherwise.

In one implementation, the plasma reactor may include a pair of electrodes oriented in a plane within an enclosure or chamber. A large voltage difference across the electrodes forms and maintains a plasma within the chamber. A sheath may be attached to each electrode, with each sheath including a strike point surface oriented to face the other sheath. The strike point surface and relative orientation to the other sheath helps induce a plasma arc between the sheaths. For example, the sheaths may be electrically conductive and relatively positioned such that a plasma arc may be generated between the strike point surfaces of the sheaths rather than at some other point along the electrodes. In this manner, a strike point or a plurality of strike points may be encouraged within the plasma reactor at a location between the sheaths rather than along the surface of the electrode. In another example, the sheaths may be constructed of a durable material to reduce the wear on the electrodes from the multiple plasma arc strikes, particularly an initial arc, that may occur within the reactor. In some instances, the plasma arc may be a gliding-arc type plasma reactor such that the plasma arc “glides” up the electrodes. The system is designed such that the arc is initiated at the sheaths and then glides away from the sheaths. The sheaths, in one example, may therefore include a transition area, which may be an angled or beveled portion, that provides a transition for the gliding-arc to move from the sheath onto the electrode without disrupting the arc so that it may travel up the electrode.

One or both of the electrodes of the plasma reactor may include a channel for cooling fluid to remove heat from the electrode. In particular and in one example, heating of the outer surface of the electrode due to the plasma arc may be transferred to the cooling fluid pumped through a cooling channel through the electrode. In some lower temperature implementations, the electrode may include a solid core of a conductive material. One or more of the electrodes may also include an outer coating of a material that is resistant to wearing, oxidation, and/or ionization from the plasma arc to further reduce the wear on the electrodes.

The plasma reactor may also include a gas injection system to introduce a gas into the chamber for interacting with the plasma arc. The gas may be injected into the chamber of the reactor through one or more pipes that may or may not include an adjustable nozzle. The nozzle may direct air flow, including the gas, at a location at which the plasma arc may occur. For example, the onset of the plasma arc is most likely to occur between the sheaths such that the nozzle may direct the inflow of gas to a location at or near the area between the sheaths. Directing the inflow of gas to the strike point of the plasma arc may aid in directing the glide of the arc up the electrodes post-strike. Further, the nozzle may be, in some implementations, a reducing nozzle that increases the velocity of the gas entering the chamber. In some implementations, the nozzle may include adjustable properties that are adjusted in response to a condition or measurement of the plasma reactor to increase or decrease the pressure within the chamber. For example, a measurement of a gas pressure within the chamber may be taken and a size of an opening of the nozzle may be adjusted to increase or decrease the pressure within the chamber.

The plasma reaction device disclosed herein provides for creation of a nonthermal plasma within the chamber for nitrogen fixation at a high efficiency. The device provides for a long lifetime of components within the device and easy replacement and maintenance of the components of high-wear items. These and other advantages are gained through the devices and methods described herein.

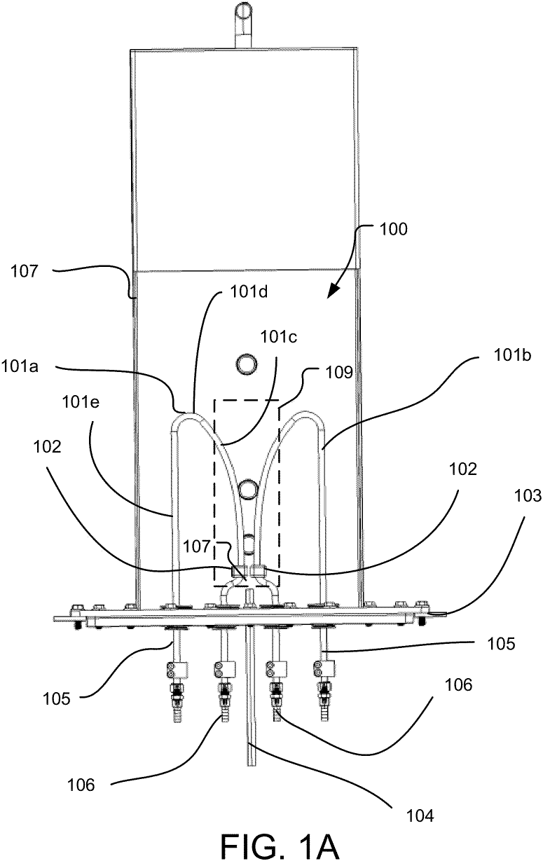

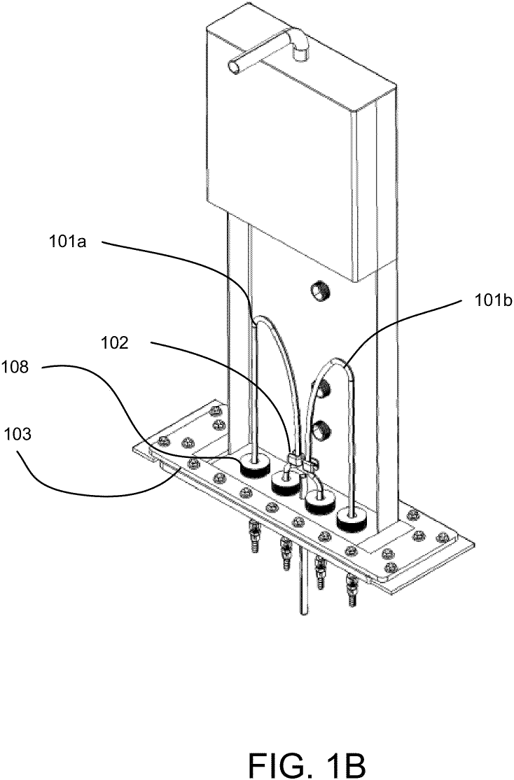

FIGS. 1A and 1B are front and isometric views of a plasma reactor with a front panel removed to illustrate various components within an interior chamber 100 of the reactor. FIGS. 1A-1B will be referred to hereafter simply as FIG. 1. In some instances, the plasma reactor may be used to produce nitric acid, may be a component of a broader nitrogen fertilizer producing system, and may be used in other system or otherwise. The chamber 100 may include two electrodes 101a, 101b between which a large voltage difference is applied to initiate an arc and form and maintain a plasma within the chamber. The plasma generated within the interior may be nonthermal in nature.

Each electrode 101 may comprise a conductive material. In one example, the electrode is a conductive tubular structure entering the chamber 100 through a baseplate 103 and connected to a power source (not shown) exterior to the chamber 100. The electrode defines a decreasing radius arc area 101c from the strike plate to a return area 101d where the electrode defines a straight return 101e to an exit port from the chamber. The decreasing radius arc area defines a region where the electrodes diverge from each other with the electric separation between the electrodes being closest at the strike plates 102; hence, an arc is initiated at the strike plates. More generally, the electrodes 101 may be shaped to include a portion 109, which may encompass the strike plate and the diverging area away from the strike plate, in which the two electrodes are located sufficiently close for formation of the plasma arc. The other portions of the electrodes 101 within the chamber 100 are relatively positioned sufficiently away from each other to prevent arcing between the electrodes.

In one specific example, the electrodes 101 may be separated from each other where the electrodes emerge from the baseplate 103 such that arcing between the electrodes does not occur. However, in one example, since the electrodes are also continuous tubulars that include cooling fluid, the electrodes must converge to a distance to enable arc generation. At this location, above the entry point into the chamber, the electrodes converge and immediately at the convergence are the respective strike plates. The strike plates have the least separation distance and hence the arc forms at the strike plate not at the electrode proximate and below the strike plate. The injection of gas, discussed below, pushes the arc upward along the decreasing radius and diverging portions of the electrodes rather than allowing the arc to stagnate or move in the wrong direction toward the entry points into the chamber.

As discussed, each of the electrodes 101 may enter and exit the chamber 100 through a baseplate 103. More particularly, the baseplate 103 may include one or more holes through which an input end 105 and an output end 106 of the electrode 101a may enter and exit the chamber 100, respectively. In one implementation, access to the chamber may be provided by detaching the baseplate 103 from the rest of the reactor housing. Other plasma reactor designs provide for the electrodes to enter the chamber through one side of a housing and exit through another, such that servicing the electrodes and/or chamber requires removal of multiple sides of the chamber. By providing the entry and exit locations for the electrodes 101 on the same side of the chamber 100 (i.e., the bottom of the chamber), increased serviceability of the plasma reactor is gained.

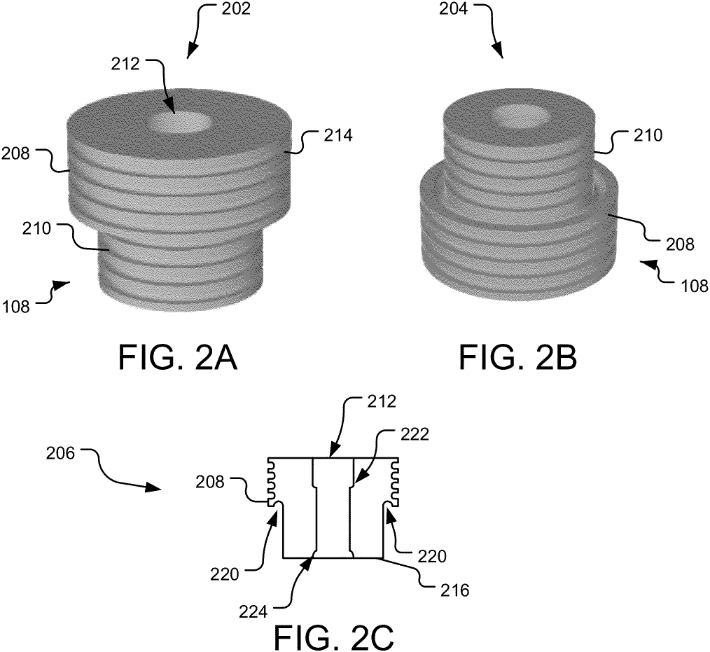

Each of the one or more access holes in the baseplate 103 may include a high-voltage electrical feedthrough, which may be a bushing 108, that electrically isolates the electrode from the housing, or more particularly the base plate, and forms a seal to maintain a vacuum within the chamber 100 of the plasma reactor. At each point where an electrode passes into the chamber, it may pass through a corresponding bushing. In one implementation, the bushings are ceramic, although other non-conductive materials are contemplated. FIG. 2A illustrates a top 202 perspective view of a first example of the bushing 108, FIG. 2B illustrates a bottom 204 perspective view of the first example of the bushing 108, and FIG. 2C is a cross-section diagram 206 of a second example of the bushing. The first bushing may be cylindrical in shape with a top portion 208 that has a larger circumference than a bottom portion 210. The bushing 108 may be oriented in a receiving hole in the baseplate 103 such that the top, wider diameter, portion 208 is within the plasma chamber 100 above the baseplate and the bottom portion 210 extends below the baseplate outside of the interior of the chamber. An electrode receiving hole 212 through the center of the bushing 108 provides for the electrode to pass through the bushing while maintaining electrical isolation with the baseplate 103. Pressurization within the chamber may press down on the top portion 208 of the bushing thereby sealing the planar annular area abutting the base plate around the hole that the bushing is positioned in. It is also possible to include a sealing ring or sealant where the larger diameter portion of the bushing engages the area around the hole in the base plate.

The bushing may include one or more ripples or ribs 214 that circumvent the outer surface of the top portion 208 and/or the bottom portion 210 of the bushing. The ribs 214 may increase a distance between the electrode 101 passing through the center of the bushing and the baseplate 103 to reduce or prevent the possibility of the high-voltage electricity traveling through the electrode to conduct along the bushing to the baseplate, potentially causing a short for the electrode. In the example illustrated in FIG. 2B, the outer surface of the lower portion 216 of the bushing 108 may be smooth and include no ribs. In general, either, neither, or both of the top portion 208 and/or bottom portion 210 of the bushing 108 may include the ribs 214. The bushing 108 may also include a mating groove 220 that circumvents the outer surface of the bushing at the junction of the top portion 208 and the bottom portion 210. The mating groove 220 is located on the bushing 108 at the point in which the bushing contacts the baseplate 103 when installed. The mating groove 220 may aid in the application of a glue to hold the bushing 108 in place on the baseplate 103 by maximizing the surface area of the bushing contacting the baseplate while providing a reservoir in which glue may reside between the bushing and the baseplate (or other surface to which the bushing is glued).

In addition, the electrode hole 212 through the center of the bushing 108 may include glue reservoirs in the upper portion 208 and the lower portion 210, 216. As best shown in the example of FIG. 2C, the electrode hole 212 may include a first glue reservoir 222 in the top portion 208 of the bushing 108. The first glue reservoir 222 may circumvent the inner surface of the bushing at the junction of the top portion 208 and corresponding electrode and provide a location in which glue may reside to hold the electrode 101 within the electrode hole 212 while maintaining a seal within the chamber 100. The lower portion 216 of the bushing 108 may also include a second glue reservoir 224 within the electrode hole 212 in which glue may reside to hold the electrode within the bushing. In many cases, the metal electrode 101 may experience a thermal cycling as the reactor operates. As such, a pliant, soft glue may be used to glue the electrode within the bushing 108 to help reduce stress and mitigate the chance of the bushing cracking due to the thermal cycling of the electrode 101. The glue reservoirs discussed above allow glue to pool and seep down into the inner portion of the electrode-bushing interface to provide a more consistent and efficient gluing of the electrode in place. The material of the bushing 108 may also be selected, in some examples, to match the coefficient of thermal expansion to the metal of the electrode 101 to ensure an elastic fit and reduce cracking of the bushing due to thermal stresses as the bushing heats and cools.

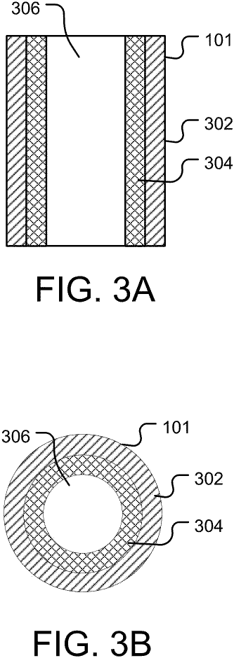

The electrodes may include features to mitigate damaging effects from thermal cycling of the electrodes 101 during use of the reactor. As mentioned, in various possible examples the electrodes may be tubular members through which coolant may be pumped. In one specific example and referring to FIG. 3A (side section view) and 3B (top section view), the electrode defines a channel 306 through the center of the electrode 101 and through which coolant may be circulated. As such, the electrode 101 may be a hollow tube with an inner chamber 306 configured to receive the cooling liquid, such as through inlet 105 of baseplate 103, which may flow through the electrode 101 and out of outlet 106. The cooling fluid may be any heat transferring fluid that is sufficiently non-conductive and includes a high heat capacity. In one example, the cooling liquid may be deionized water, although other cooling liquids may also be used in the plasma reactor. In the case of the deionized water example, one or more precautions may be taken to ensure that the water remains adequately insulating and interlocks are in place in case of a cooling water failure. To circulate the cooling fluid through the center channel 306 of the electrodes 101, the inlet 105 and outlet 106 may be fluidly connected to a reservoir containing the cooling fluid. In some instances, a pumping mechanism may be used to pump the cooling fluid through the electrodes to draw heat from the electrodes.

An inner conductive layer 304 may surround the fluid channel 306 of the electrodes and may, in some instances, comprise an easily machined and thermally conductive material, such as copper, although other materials may also be used. The inner conductive layer 304 may separate an outer coating 302 of the electrode from the cooling fluid in the channel 306 and may conduct heat received at the outer coating 302 to the cooling liquid to reduce the direct thermal effects on the outer surface of the electrode. The outer coating 302 may comprise a refractory material that coats the outer surface of the inner conductive layer 304. The refractory material of the outer coating 302 may be bonded to the inner conductive layer 304 via electrodeposition, sputtering, furnace brazing, or other technique for bonding a material to the inner layer. The thickness of the outer coating 302 may be varied in accordance with the expected wear on a particular area or based on an intended cooling need for the electrode. In one implementation, the thickness of the outer coating 302 may be greater within the portions (box 109 of FIG. 1A, for example) of the electrodes on which the plasma arc is intended to occur more frequently within the chamber 100 than other portions of the electrode (such as near the baseplate 103). Further still, the thickness of the outer coating 302 may be greater on a side of the electrode 101 that faces the other electrode than on the side of the electrode facing away from the corresponding electrode. For example, within the decreasing radius area where the electrodes diverge and the arc glides, the thickness of the outer coating 302 of electrode 101a may be thicker on the side that faces electrode 101b and where the arc will be between the electrodes in comparison to the thickness of the outer coating facing away from the opposite electrode. The outer coating 302 may also be thinner in portions of the electrode 101 that experience high temperatures to allow for a more efficient heat conduction to the cooling fluid in the inner channel 306 of the electrode. In another implementation, the outer coating 302 may be replaced or added in addition to a corrosion resistant material to protect the electrodes 101 from NOx, nitric acid, or oxidative conditions present in the chamber 100 of the plasma reactor. In still other implementations of the electrodes 101, channel 306 may not be hollow but may instead be filled with a heat-conductive solid element, such as copper or aluminum, such as in low-power cases in which cooling is sufficient without a cooling liquid pumped through the electrode 101.

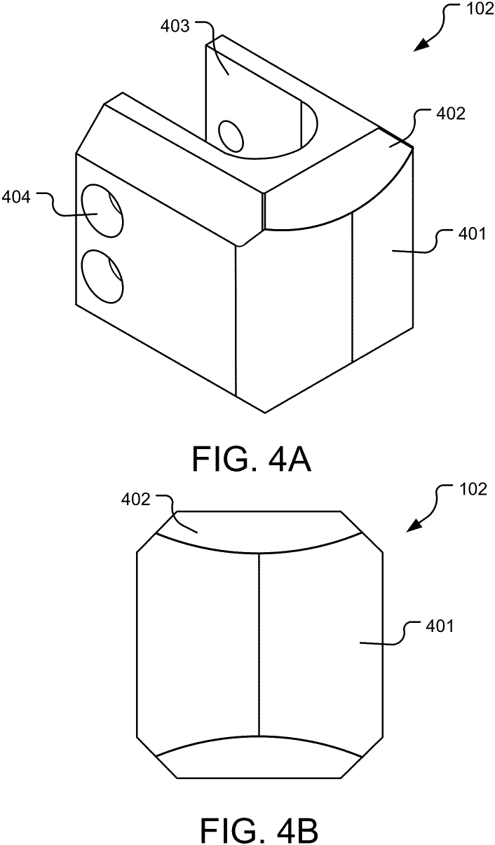

Returning to the chamber 100 of FIG. 1, a gas may be introduced into the chamber 100 through injection via pipe 104, which may or may not have a nozzle device at gas input point 107. The pipe 104 and nozzle 107 may be constructed from a conductive or non-conductive material. In implementations in which the pipe 104 and/or nozzle 107 are constructed from conductive material, the distance between gas input point 107 and arc portion 109 of the electrodes 101 may be sufficient to ensure that a plasma will not be preferentially formed between the two electrodes 101 and the pipe and/or nozzle. As explained in greater detail below with reference to FIG. 4, the gas nozzle 107 may, in some instances, be shaped or pinched to direct gas flow at and around the plasma occurring in area 109.

In addition and as introduced above, the electrodes 101 may be reinforced at high wear points with one or more sheaths 102 that attach to the electrodes at a desired striking point or a plurality of strike points of the plasma (where the electrodes are nearest to each other within portion 109). In general, the sheaths 102 may be used to dictate the strike point by decreasing effective electrode separation distance. In many cases, the sheaths 102 may be easily removable from the electrodes 101 and serviceable or replaceable to reduce the cost of maintenance or repairs of the plasma reactor.

FIG. 4A is a perspective view of one implementation of the striking sheath 102 of the plasma reactor and FIG. 4B is a front view of the striking sheath. The striking sheath is used to reinforce high wear portions of the electrodes 101 due to the plasma arc. In one implementation, the sheath 102 may be composed of materials that are more arc resistant than outer coating 302 of the electrode 101 to which the sheath is attached. Because the sheathes are positioned and dimensioned to initiate the arc between the respective electrodes, the sheath 102 may be composed of a more expensive, durable material than the electrodes, such as copper-tungsten alloy, molybdenum alloy, or platinum, to withstand the higher number of arc strikes that will occur over a period of time as compared to other portions of the electrode where the arc may glide but will not be initiated. This enables an economical use of specialty materials by limiting the more expensive materials to the sheaths instead of producing the entire electrode from the expensive material.

As shown in FIGS. 4A and 4B, the sheath 102 may include a nearly flat front face 401 (also known as a strike plate) to provide an area for the plasma arc to strike. More particularly, the sheath 102 may be oriented on one electrode 101a such that the front face 401 is oriented toward a front face of a corresponding sheath on the second electrode 101b. As the front face 401 of the sheath 102 extends away than the electrode 101 toward the other sheath or corresponding electrode, attaching the sheath to the electrode may reduce the distance between the electrodes 101 of the chamber 100 at the sheath location. Further, as the sheaths 102 are conductive, the sheaths generate a likely strike point or plurality of strike points for the plasma arc at a location between the sheaths 102. By inducing the strike point or plurality of strike points at the more durable sheath 102 component, the electrodes 101 may suffer less wear over time as plasma is induced within the reactor.

In one implementation, the front face 401 may be a relatively narrow plate to concentrate the striking of arcs and to provide a concentrated electric field. One skilled in the art may realize that the tradeoff between the two may be related to the voltage used to strike and drive the arc. In other implementations, the front face 401 may provide an area for a multitude of potential strike points, so as to decrease the wear and provide heat recovery time at any one strike point. In still other implementations, the front face 401 of the sheath 102 may include beveled portion 402 at the location where the front face is adjacent the electrode to provide a transition portion for the plasma arc from the strike face 401 onto the electrode 101. In particular, the plasma arc reactor described herein may be a gliding-arc reactor in which the plasma arc may, upon a strike, traverse up the electrodes 101 from the strike point before dissipating at a condition-dependent point at which the distance between the electrodes becomes too great for the electric field generated between the electrodes to sustain the arc across the air gap between the electrodes. Through the sheaths 102, the plasma arc may strike somewhere along the front face 401 and travel along the front face and onto the electrodes and the plasma arc glides away from the strike plate along the diverging electrode region. To facilitate or aid the transition of the plasma arc from the sheath 102 to the electrode 101, the front face 401 may include one or more beveled portions 402 located near the top of the front face. In general, the angled portion 402 may be less than a 90 degree angle from the near vertical front face to the near horizontal top of the sheath to facilitate the plasma arc transition onto the electrode 101.

The sheath 102 may be affixed and/or removed to a corresponding electrode 101 using set screws in holes 404 or by a similar technique. In particular, an electrode 101 may be located in a curved receiving portion 403 of the sheath opposite the front face 401. The set screws may pass through holes 404 in the side of the sheath to contact the electrode 101 in the receiving portion 403 or to engage a threaded hole opposite the screw holes or to press against the electrode. In some implementations, precautions must be undertaken to avoid undue stress on the sheath 102 from these set screws. For example, the sheath 102 may be constructed from a material that is sufficiently malleable to withstand a large deformation upon screw tightening to pinch the electrode 101 and remain in place on the electrode. In an alternative implementation, some or all of holes 404 may be tapped such that the screw or other attachment itself contacts the electrode 101 to hold the sheath in place. In these implementations, the set screw size, material, and threading may be designed or chosen to resist corrosion and ensure reliable performance after operation in the plasma reactor for long periods. In a particular implementation, holes 404 may instead be a tapped region of cavity 403, such that a larger set screw may be secured perpendicular to their illustrated location and tightened against the electrode 101. The fastener may provide even pressure to the electrode 101 to ensure a good electrical contact between the sheath 102 and the electrode 101 as the interface quality may impact the electrical performance of the chamber 100. In general, good thermal and electrical contact between the electrode 101 and inner sheath face 403 may extend the useful life of the sheath. In some implementations, thermal pastes, epoxies, or precision press fitting may be used with the sheath 102 to achieve thermal and electrical contact between the sheath and the corresponding electrode 101. In other implementations, the sheath may be secured with longer-term metal bonding techniques such as furnace brazing or welding. In yet another implementation, inner surface 403 may be tapped such that a set screw may be used without holes 404.

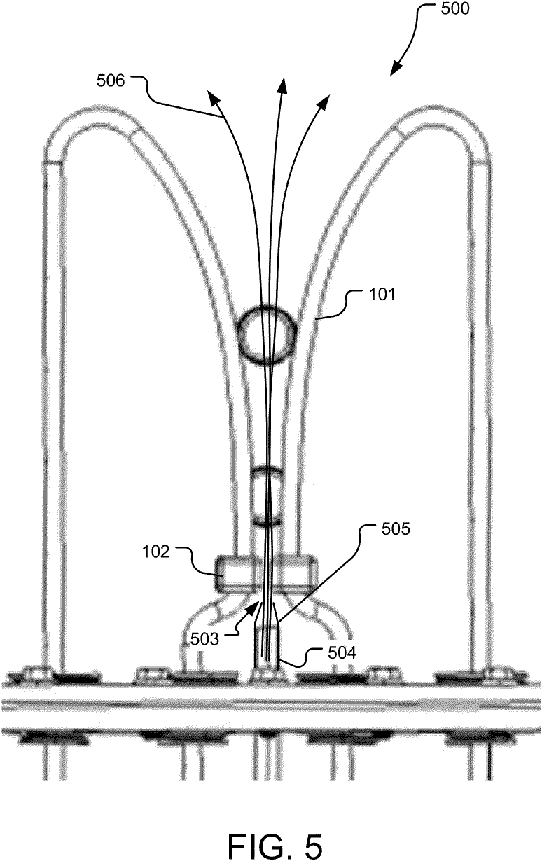

As mentioned above, a gas may be introduced into the chamber 100 and processed by the plasma through an injection via pipe 104 which may or may not have a nozzle at gas input point 107. FIG. 5 is a diagram of an interior chamber 500 of a plasma reactor illustrating such a gas-injection nozzle 505. In particular, the electrodes 101 and sheaths 102 of the chamber 100 are illustrated and may operate as discussed above. A gas 506 may be injected into the chamber through pipe 504. In one implementation, the pipe 504 may include a nozzle 505 for directing gas flow, including the gas 506 injected into the chamber 100, at a location at which the plasma arc may occur. For example, the plasma arc is most likely to occur between the sheaths 102, as discussed above. The nozzle 505 may therefore be configured to direct the inflow of gas 506 to a location at or near the area between the sheaths 102. Directing the inflow of gas 506 to the strike point or plurality of strike points of the plasma arc may aid in directing the glide of the arc up the electrodes 101. A rapid flow of the gas 506 through the strike point may cause the plasma arc to glide up the electrodes 101 rapidly enough such that the plasma obtains the proper electric field or plasma temperatures needed for fertilizer production.

The nozzle 505 may be, in some implementations, a reducing nozzle that increases the velocity of the gas entering the chamber 500. A high-velocity injection of the gas 506 may be advantageous for the energy efficiency of the plasma process as directing the gas to the strike point may aid in inducing the plasma strike. The opening of the nozzle 505 may be of similar cross-sectional area to the pipe 504 but may differ in shape. In one implementation, opening 503 may include a slit which promotes gas flow in a plane parallel to the plane defined by the electrodes 101. In another embodiment, opening 503 may be a slit which promotes gas flow in a plane perpendicular to the plane defined by the electrodes 101. In yet another embodiment, nozzle 505 may include adjustable properties that are adjusted in response to a condition or measurement of the plasma reactor. For example, a measurement of a gas pressure within the chamber 500 may be taken and a size of the opening 503 of the nozzle 505 may be adjusted to increase or decrease the pressure within the chamber. In another example, a duration of the plasma arc during a glide up the electrodes may be determined and the nozzle 505 shape or size may be adjusted accordingly to either increase or decrease the distance of the glide. For example, if the duration of the plasma arc is above a particular threshold duration or lasts too long, the nozzle 505 may be adjusted to increase the velocity of the gas 506 being injected by the pipe 504 into the chamber 500. If, on the other hand, the duration of the plasma arc is below a particular threshold duration, the nozzle 505 may be adjusted to decrease the velocity of the gas 506 being injected by the pipe 504 into the chamber 500. In general, any measurement or condition of the chamber 500 may be used to adjust the nozzle 505 of the gas-injecting pipe 504.

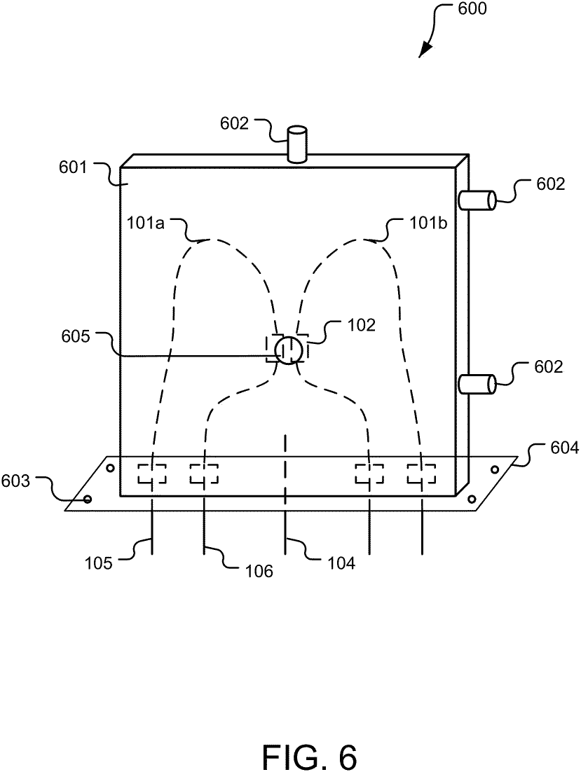

FIG. 6 is a diagram of an exterior of a plasma reactor that may house the interior portions of the plasma reactor discussed above in a sealed chamber. One or more of the above-described components are illustrated in FIG. 6 as dashed lines to indicate these components are located within an enclosure 601, including the electrodes 101a, 101b and sheaths 102. In general, the exterior 600 of the plasma reactor includes a rectangular enclosure 601 mounted on the baseplate flat surface 604. In some implementations, enclosure 601 is shaped to match the plane of a plasma glide. Reactor gas may be injected into and contained inside the enclosure body 601. In particular, the gas may be injected into the enclosure 601 via pipe 104, as discussed above. In some instances, the enclosure 601 may be made from stainless steel or another corrosion resistant material. One or more gas output ports 602 may be located on an edge of the enclosure that allows gas flow out of the plasma reactor enclosure. In some embodiments, gas output ports 602 may be larger than gas input pipe 104 or nozzle for ease of gas flow out of the reactor due to internal pressure within the enclosure. Allowing each of gas flow out of the reactor may increase efficiency by preventing reacted gas from re-entering the plasma region. The output ports 602 may be located on any outer surface of the enclosure 601, including the top or a side surface. In some implementations, the top surface of the enclosure 601 may be configured in a gradual funnel shape to direct gas flow out, perhaps in conjunction with the output port 602 or without.

The enclosure 601 may be configured to mount the baseplate 103 discussed above with reference to FIG. 1. One or more connector holes 603 may be located through the flat surface 604 that align with corresponding holes in the baseplate 103. One or more connectors, such as using bolts, screws, or other connecting fasteners, may pass through the connector holes 603 in the enclosure flat surface 604 and the baseplate 103 to hold the enclosure together with the baseplate. In some implementations, this connection is made gas-tight using a gasket and/or flange mechanism. In additional implementations, a removable portion of baseplate 103, containing one or more of bushings 108, gas pipe 104, and electrodes 101, may be a smaller region within baseplate 103 rather than the entire baseplate for ease of maintenance and replacement. The enclosure 601 may also include one or more viewing windows 605 for optical viewing of plasma within the enclosure 601. The viewing windows 605 may be made from a transparent or semi-transparent material, such as quartz, borosilicate, and the like. In addition, the enclosure 601 may include one or more sensors for telemetry of the plasma reactor (temperature, pressure, wavelength, imaging). Such sensors may communicate with a computing device outside of the enclosure through a wired or wireless communication. The computing device may process and, in some instances, display the plasma reactor telemetry.

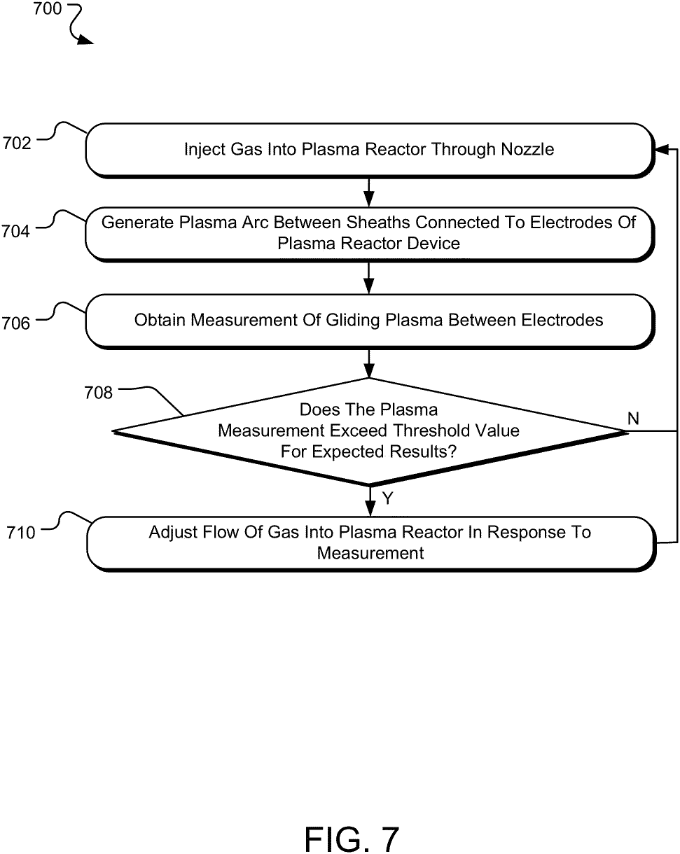

FIG. 7 is a flowchart of a method 700 for operating a plasma reactor, such as the plasma reactor illustrated in FIGS. 1-6 and described above. One or more of the operations of method 700 may be performed by a computing device in communication with one or more components of the plasma reactor, such as a power source, a gas injector system, and or an adjustable or non-adjustable nozzle. The operations may be executed through one or more software programs, one or more hardware components, or a combination of both hardware and software.

Beginning in operation 702, a gas 406 may be injected into the plasma reactor through the nozzle 505 of an input pipe 504. As explained above, a gas injection system may be attached to the input pipe 504 for injecting gas into the chamber of the plasma reactor. As described, a nozzle 505 may be located at the output end of the pipe and may direct the injected gas toward a strike point of the plasma reactor. In operation 704, a plasma arc may be generated within the chamber of the plasma reactor. The plasma arc may occur between two sheaths attached to opposite electrodes of the reactor. The sheaths may shorten a distance between the two electrodes of the plasma reactor to encourage arc generation between the two sheaths. As the gas is directed toward a similar location between the two sheaths, the gas may interact with the plasma arc to generate an output gas within the chamber. In some instances, the output gas may flow out of the chamber through one or more output ports of the plasma reactor and used, in some circumstances, in nitrogen fertilizer generation.

In operation 706, a measurement of some aspect of the plasma arc within the chamber of the plasma reactor may be obtained. In one implementation, the plasma arc may be a gliding-arc that traverses a length of the electrodes and the measurement may be obtained of the gliding-arc. The measurement may be obtained from one or more sensors in, on, or adjacent to the plasma reactor. In general, any performance measurement of the device may be obtained. In other examples, a temperature, a gas flow, and/or a cooling liquid flow may be measured and used to control the flow of gas into the chamber. In operation 708, it may be determined if the obtained measurement exceeds a threshold value for an expected result or performance of the plasma reactor. For example, a sensor may obtain a duration of a plasma arc. The duration may be compared to a threshold value to determine if the plasma arc is maintained for an expected time period. If the obtained measurement exceeds the threshold value, the adjustable nozzle 505 may be configured to alter the gas being input into the chamber in response to the measurement. For example, the flow of gas through the nozzle 505 may be adjusted in response to the obtained measurement. Other adjustments to the components of the plasma reactor may also be performed based on one or more measurements of the plasma reaction. For example, a power source may be controlled to adjust a voltage potential between the electrodes 101 of the chamber.

In another example, a gas interlock system may be integrated with the chamber 100 to control the flow of gas into the reactor chamber 100. The interlock system may control a power supply to cease power to chamber for instances in which gas is not flowing from the reactor to prevent the reactor from overheating when an arc does not move from the strike point and there is no gas to carry the heat out. In another example, the interlock system may control the power supply to cease power to the chamber if a cooling fluid (such as the cooling fluid in the electrode 101) to the chamber is not running. Such a control may be measured by the pressure inside the cooling water tubes of the electrode and control of the power supply may occur according to the measured pressure. Other control schemes and systems may also be incorporated with the plasma reactor chamber to prevent damage to some or all of the chamber in response to a measured operating condition of the chamber. Circumstances in which the obtained measurement does not exceed the threshold value for expected results, the process may return to operation 702 to continue generating the plasma arc.

Disclosed herein is a plasma reactor configured to produce oxidized nitrogen species from a stream composed of nitrogen, oxygen, oxidized nitrogen species, and other trace gases. The plasma may be formed between two electrodes by striking the arc at a narrow point and then driving the arc down the electrodes with gas flow. The electrodes may be arranged in a ‘gliding-arc’ design and may comprise an inner tube allowing for cooling fluids to be circulated made from a highly conductive material such as copper, silver, or aluminum with an outer coating of a heavier element with a high melting point such as tungsten, iridium, or platinum. The electrodes may be mounted on a removable baseplate to facilitate maintenance of the electrodes. Said removable baseplate may be configured to be secured to an enclosure and make a gas-tight seal. The enclosure may be configured to direct gas flow in the plane of a propagating plasma arc and may include ports for optical viewing or telemetry sensors. The optical viewing ports may be composed of quartz enclosed in stainless steel with a silicon gasket and the telemetry sensors may be thermocouples, pressure gauges, wavelength sensors, or imaging devices.

The plasma reactor may include a ‘narrow point’ or ‘strike point’ between said electrodes that is reinforced with a removable and replaceable sheath composed of a conductive, refractory material. The replaceable sheath material composition may be a copper-tungsten alloy, tungsten-coated copper, molybdenum-coated aluminum, or another combination of conductive and refractory materials. Further, the replaceable sheath may be configured to be attached, tightened, loosened, or removed with set screws. The gas may flow in through a narrow nozzle between the electrodes for increased and targeted gas velocity relative to other regions of the reactor and the nozzle may be used to propagate a plasma arc. Further, in some instances, the outer surface of the plasma chamber may be insulated with any type of insulating material. Such insulation may be included to control the internal gas conditions within the chamber and/or reduce radiative heat flow to the surrounding environment.

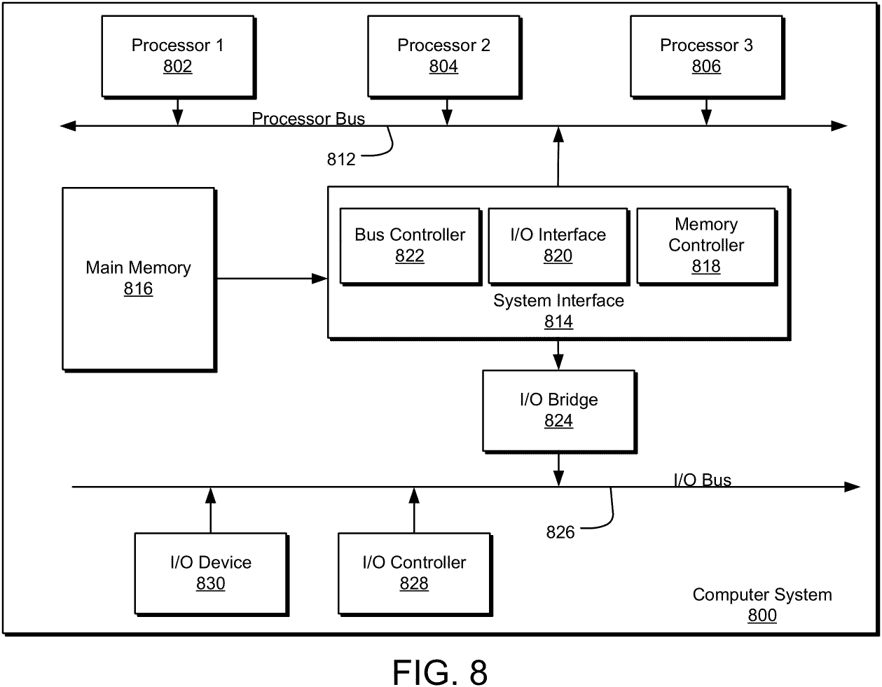

FIG. 8 is a block diagram illustrating an example of a computing device or computer system 800 which may be used in implementing the embodiments of the network disclosed above. In particular, the computing device of FIG. 8 is one embodiment of a computing device that performs one or more of the operations described above with reference to FIG. 7. For example, the computer system 800 may obtain or receive a measurement of the gliding plasma and control the flow of gas into the plasma reactor in response to the measurement. The computer system (system) includes one or more processors 802-806. Processors 802-806 may include one or more internal levels of cache (not shown) and a bus controller or bus interface unit to direct interaction with the processor bus 812. Processor bus 812, also known as the host bus or the front side bus, may be used to couple the processors 802-806 with the system interface 814. System interface 814 may be connected to the processor bus 812 to interface other components of the system 800 with the processor bus 812. For example, system interface 814 may include a memory controller 818 for interfacing a main memory 816 with the processor bus 812. The main memory 816 typically includes one or more memory cards and a control circuit (not shown). System interface 814 may also include an input/output (I/O) interface 820 to interface one or more I/O bridges or I/O devices with the processor bus 812. One or more I/O controllers and/or I/O devices may be connected with the I/O bus 826, such as I/O controller 828 and I/O device 830, as illustrated.

I/O device 830 may also include an input device (not shown), such as an alphanumeric input device, including alphanumeric and other keys for communicating information and/or command selections to the processors 802-806. Another type of user input device includes cursor control, such as a mouse, a trackball, or cursor direction keys for communicating direction information and command selections to the processors 802-806 and for controlling cursor movement on the display device.

System 800 may include a dynamic storage device, referred to as main memory 816, or a random access memory (RAM) or other computer-readable devices coupled to the processor bus 812 for storing information and instructions to be executed by the processors 802-806. Main memory 816 also may be used for storing temporary variables or other intermediate information during execution of instructions by the processors 802-806. System 800 may include a read only memory (ROM) and/or other static storage device coupled to the processor bus 812 for storing static information and instructions for the processors 802-806. The system set forth in FIG. 8 is but one possible example of a computer system that may employ or be configured in accordance with aspects of the present disclosure.

According to one embodiment, the above techniques may be performed by computer system 800 in response to processor 804 executing one or more sequences of one or more instructions contained in main memory 816. These instructions may be read into main memory 816 from another machine-readable medium, such as a storage device. Execution of the sequences of instructions contained in main memory 816 may cause processors 802-806 to perform the process steps described herein. In alternative embodiments, circuitry may be used in place of or in combination with the software instructions. Thus, embodiments of the present disclosure may include both hardware and software components.

A machine-readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 816. Common forms of machine-readable medium may include, but is not limited to, magnetic storage medium; optical storage medium (e.g., CD-ROM); magnetooptical storage medium; read only memory (ROM); random access memory (RAM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

We claim:

1. A plasma reactor comprising:
a first electrode and a second electrode, each comprising a strike portion proximate to a corresponding strike portion of the other of the first electrode and the second electrode;
a gas injector injecting a gas stream between the first electrode and the second electrode, wherein a plasma arc is generated between the first electrode and the second electrode to oxidize the gas stream; and
an enclosure through which the first electrode and the second electrode and the gas injector enter a sealed chamber, the enclosure comprising a removable portion to provide service access to the sealed chamber.

2. The plasma reactor of claim 1 wherein the gas stream comprises nitrogen, oxygen, and an oxidized nitrogen species.

3. The plasma reactor of claim 1 wherein each of the first electrode and the second electrode comprises:
an inner tube through which a cooling fluid flows; and
a conductive layer around the inner tube.

4. The plasma reactor of claim 3 wherein each of the first electrode and the second electrode comprises an outer coating around the conductive layer, the conductive layer transferring heat on the outer coating to the cooling fluid flowing in the inner tube to reduce a thermal effect on the outer coating.

5. The plasma reactor of claim 3, further comprising:
a water cooling interlock to control a flow of the cooling fluid through the inner tube based on a measured operating condition of the plasma reactor.

6. The plasma reactor of claim 4 wherein a thickness of the outer coating varies along a length of each of the first electrode and the second electrode, the outer coating of each of the first electrode and the second electrode being thicker on a side facing the other electrode.

7. The plasma reactor of claim 1 wherein each of the first electrode and the second electrode comprise:
a first region in which the first electrode and the second electrode are located near each other to generate a plasma strike between the first electrode and the second electrode; and
a second region in which first electrode and the second electrode diverge from each other.

8. The plasma reactor of claim 7, further comprising:
a first sheath mounted on the first electrode and a second sheath mounted on the second electrode, the first sheath and the second sheath mounted at the first region of the first electrode and the second electrode.

9. The plasma reactor of claim 8 wherein both of the first sheath and the second sheath comprises:
a flat front strike face oriented toward the flat front strike face of the opposite sheath; and
a beveled portion angling from the flat front strike face toward the corresponding electrode to transition a plasma arc onto the corresponding electrode.

10. The plasma reactor of claim 1 wherein the gas injector comprises a nozzle, wherein the nozzle increases a velocity of the gas stream.

11. The plasma reactor of claim 1 wherein the enclosure houses the first electrode and the second electrode, the enclosure configured to direct the gas stream in a plane of a propagating plasma arc.

12. The plasma reactor of claim 11 wherein the enclosure further comprises an optical port for viewing an internal portion of the enclosure.

13. The plasma reactor of claim 12 wherein the enclosure further comprises a sensor for measuring an operating condition within the enclosure.

14. The plasma reactor of claim 1, further comprising:
a gas flow interlock to control the injection of the gas stream based on a measured operating condition of the plasma reactor.

15. The plasma reactor of claim 1 further comprising:
a baseplate comprises a plurality of electrical feedthroughs through which the first electrode and the second electrode pass into the sealed chamber, each of the plurality of electrical feedthroughs comprising:
a cylindrical shape with an outer surface;
an electrode hole through a center of the cylindrical shape defining an inner surface; and
a plurality of ribs circumventing the cylindrical shape on the outer surface.

16. The plasma reactor of claim 15 wherein each of the plurality of electrical feedthroughs further comprise:
an outer glue reservoir circumventing the cylindrical shape on the outer surface; and
an inner glue reservoir circumventing the inner surface of the electrode hole.

17. A method for controlling a plasma reactor, the method comprising:
providing a first electrode and a second electrode, each comprising a strike portion proximate to a corresponding strike portion of the other of the first electrode and the second electrode;
providing an enclosure through which the first electrode and the second electrode and a gas injector enter a sealed chamber, at least a portion of the enclosure removable to provide service access to the sealed chamber; and
injecting, via a gas injector, a gas stream between the first electrode and the second electrode, wherein a plasma arc is generated between the first electrode and the second electrode to oxidize the gas stream.

18. The method of claim 17, further comprising:
receiving, from a sensor located within the enclosure, a measurement corresponding to the plasma arc; and
adjusting, based on the received measurement, the gas injector.

19. The method of claim 18 wherein the measurement is at least one of a temperature within the enclosure, a gas flow, or a cooling liquid flow through at least one of the first electrode and the second electrode.

20. The method of claim 18 wherein adjusting the gas injector comprises adjusting a nozzle device to increase or decrease the gas stream.
